(19) United States
(12) Patent Application Publication
(10) Pub. No.: US 2006/0193067 A1
(43) Pub. Date: Aug. 31, 2006

(54) Tilting assembly and tilting actuator having the same

(75) Inventors: Jae Kyung Kim, Ansan (KR); Chil Sung Lee, Suwon (KR); Dong Won Choi, Suwon (KR)

Correspondence Address: LOWE HAUPTMAN BERNER, LLP, 1700 DIAGONAL ROAD, SUITE 300, ALEXANDRIA, VA, 22314, US

(73) Assignee: Samsung Electro-Mechanics Co., Ltd., Suwon (KR)

(21) Appl. No.: 11/274,405

(22) Filed: Nov. 16, 2005

(30) Foreign Application Priority Data
Feb. 25, 2005 (KR) 10-2005-16118
May 31, 2005 (KR) 10-2005-46357

(51) Int. Cl. G02B 7/182

(52) U.S. Cl. 359/872; 359/879

(57) ABSTRACT

A tilting assembly and a tilting actuator having the same are provided in the present invention. The present invention comprises a stationary member having an inner space, a mirror holder having a shaft supported rotatably by the opposed sides to tilt about a shaft, and a drive unit connected to the mirror holder to apply vertical external force on the mirror holder via the reciprocal action by a magnetic field and an electric field. The present invention allows tilting movement of the mirror without any noise or vibration, saves the costs, and results in uniform tilting quality across the products.

### CLAIM OF PRIORITY

This application claims the benefit of Korean Patent Application No. 2005-16118 filed on Feb. 25, 2005, and No. 2005-46357 filed on May 31, 2005 in the Korean Intellectual Property Office, the disclosures of which is incorporated herein by reference.

### BACKGROUND OF THE INVENTION

1. Field of the Invention

The present invention generally relates to an actuator for tilting a mirror used in a display device adopting Digital Light Processing (DLP). More particularly, the present invention relates to a tilting actuator of a mirror for a DLP display device capable of tilting the mirror, by external force generated from the reciprocal action of a magnetic field and an electric field, without noise and vibrations, thereby reducing the manufacturing costs, and allowing uniform tilting quality across the products.

2. Description of the Related Art

In general, a Digital Light Processing (DLP) display device exhibits the improved reproducibility of primary color by eliminating the pixel mosaic phenomenon, a shortcoming associated with Liquid Crystal Display (LCD). As a result, DLP allows obtainment of a clear and high-luminance large-sized color image useful for the presentations in the fields like business, education, and advertisement, or entertainment such as the movies.

The DLP display device as shown in FIG. 12 includes: a lamp as a light source 10, a condensing lens 20 for condensing and irradiating the beam from the lamp 10, a color wheel 30 for separating the white light condensed from the condensing lens 20 into red R, green G, and blue B to illuminate one third on each frame, a collimating lens 40 for irradiating in a parallel direction the color-specific lights emitted from the color wheel 30, a Digital Micro mirror Device (DMD) 50 for adjusting the reflecting angle corresponding to the pixels of the color-specific lights condensed at the collimating lens 40 to form an image, and a projection lens 60 for projecting the image formed by the DMD 50 onto a screen S as a large-sized picture.

In the above DMD 50, a plurality of minute-sized micro-mirrors, each in charge of a pixel structure, are provided in two dimensions on a silicon wafer. The micro-mirrors are tilted individually at a high-speed according to the digital information provided from a regulator to the DMD 50, altering the path of the incident light to either on or off state.

Thus the pixels each regulated by the DMD 50 are enlarged through the projection lens to be displayed on the screen S in a desired, large-sized image.

In the meantime, a display device adopting DLP enlarges and projects a small-sized original image into a large-sized picture, resulting in inferior picture quality to the original image. Further, in case when a moving image is displayed at a high-speed or the viewer's eyes move fast, there have been instances in which rainbow colors are noticed in the spot with a high contrast ratio like black lines on a white background or a grid pattern between each pixel is easily perceived by the fast movement of human eyes, resulting in mediocre picture quality of the large-sized image.

Therefore, in order to enhance the resolution of the picture formed on the screen, a tilting actuator was provided between the DMD and the projection lens to allow fine tilting movement of the mirror by delicately adjusting the angle of the light incident on the screen through the DMD to induce an optical illusion.

In the prior art, it is known to adopt piezoelectric element (PZT) as driving means of the actuator for tilting the mirror so as to apply voltage on the piezoelectric element to tilt the mirror in a certain angle, but there have been problems of excessive noise and vibration whenever the piezoelectric element, the tilting driving means, and the tilting objects come in contact with each other in the tilting driving structure.

In addition, as the high cost of the piezoelectric element used in the actuator and the differences between the qualities of the piezoelectric products result in the high manufacturing costs of the finished products and the tilting actuators with varied qualities in mass production, final product manufacturers often expressed complaints.

Moreover, it is difficult and takes a considerable time to modify the design of the piezo to improve its performance, resulting in a prolonged period to upgrade the capacity of the tilting actuator, thus failing to meet the requirements of the final product manufacturer.

Furthermore, in order to alter the direction of the light to a desired direction, the conventional tilting actuator is required to tilt the mirror in ±10 degrees in the interval of 60 Hz. At this time, the flatness of the mirror should be accurately maintained within 1.2 μm.

However, once the tilting actuator and the mirror are assembled into a complete product, it is difficult and complicated to adjust the flatness of the mirror to the range within 1.2 μm.

### SUMMARY OF THE INVENTION

The present invention has been made to solve the foregoing problems of the prior art and it is therefore an object of the present invention to provide a tilting actuator for DLP display device which can tilt the mirror without noise and vibration, and save the manufacturing costs.

It is another object of the invention to provide a tilting actuator for DLP display device which allows facilitated process of improving the capacity of a tilting actuator, and a uniform tilting quality across the tilting actuators.

It is further another object of the invention to provide a tilting actuator for DLP display device capable of adjusting the flatness of the mirror easily and precisely to alter the light path formed on the screen.

In order to realize the above described objects, the present invention provides a tilting assembly including: a mirror reflecting a light from the Digital Micro mirror Device (DMD); a stationary member having an inner space; and a mirror holder having a shaft supported rotatably by the stationary member to tilt about the shaft.

Preferably, the mirror is a plate member with reflective material applied on at least one of opposed sides thereof.

Preferably, the stationary member has a shaft supporting part with a shaft groove formed by depression of the surface to place the shaft thereon.

More preferably, the shaft groove has a semicircular section to be in surface contact with the shaft.

More preferably, the shaft groove has a V-shaped section to be in line contact with the shaft.

Preferably, the shaft is formed integrally in the left and right sides of the mirror holder which faces the shaft supporting part.

Preferably, the shaft is assembled into the shaft holes formed on the left and right sides of the mirror holder which faces the shaft supporting part.

In addition, the present invention provides a tilting actuator including: a stationary member having an inner space, a mirror holder having a mirror on the top to tilt about the shaft, and a drive unit connected to the mirror holder to apply vertical external force to the mirror holder via the reciprocal action of a magnetic field and an electric field.

Preferably, the mirror is a plate member with reflective material applied on at least one of opposed sides thereof.

Preferably, the stationary member has a pair of first inner steps on the opposed inner sides, and shaft grooves formed on the first inner steps, respectively, to have the shaft seated rotatably thereon.

More preferably, the shaft groove has a semicircular section to be in surface contact with the shaft.

More preferably, the shaft groove has a V-shaped section to be in line contact with the shaft.

Preferably, the shaft is formed integrally in the left and right sides of the mirror holder which faces the shaft supporting part.

Preferably, the shaft is assembled into the shaft holes formed on the left and right sides of the mirror holder which faces the shaft supporting part.

Preferably, the mirror holder is a molded member of metal.

Preferably, the mirror holder is a molded member of resin.

Preferably, the mirror holder has a plurality of mirror supporting parts on the upper surface to prevent the horizontal shift of the mirror and to maintain a predetermined interval with the mirror.

Preferably, the shaft has means for permitting the rotation of the shaft while preventing the derailment of the shaft.

More preferably, the prevention means include a fixing plate disposed to be in surface contact with the shaft and fastening means inserted into the fastening holes of the stationary member through a pair of through holes formed on the left and right sides of the stationary member.

More preferably, anyone of the pair of the through holes is a slot.

Preferably, the tilting actuator further includes a holder pillar disposed between the mirror holder and the stationary member, and the holder pillar having an upper part to support the mirror holder and a lower part fixed on the floor surface of the stationary member.

More preferably, the holder pillar includes a cylindrical member with its lower part assembled into a pillar hole of the stationary member, and a contact ball disposed on the top of the cylindrical member to allow resilient contact with the bottom of the mirror holder.

More preferably, the cylindrical member is screwed into the pillar hole.

More preferably, the mirror holder has a lower protrusion protruding along the centerline of the shaft in the lower part of the mirror holder which is in contact with the upper part of the holder pillar.

More preferably, the lower protrusion has a contact groove in point contact with the upper part of the holder pillar.

Preferably, the tilting actuator has means for adjusting the levelness of the mirror, disposed between the mirror holder and the stationary member.

More preferably, the levelness-adjusting means has a plate spring whose center fixed to the bottom of the mirror holder, and having lateral protrusions on both sides facing the fastening holes on the second inner steps of the stationary member, and adjustment members bound to the fastening holes through adjustment holes formed on the lateral protrusions.

More preferably, the adjusting members have a coil spring resiliently supporting the lateral protrusions upward.

Preferably, the drive unit includes at least one magnet part installed on the floor surface of the stationary member, and at least one coil part connected to the mirror holder, piled up in the magnet part.

Preferably, the magnet part includes a yoke whose lower part fixed on the seating groove formed on the floor surface of the stationary member having an open top and a closed bottom, and a magnet member disposed inside the inner space of the yoke to generate a predetermined intensity of magnetic field.

More preferably, the magnet member is seated on the top of the inner step protruding in an annular shape in a predetermined height from the surface floor of the yoke.

More preferably, the yoke has an upper yoke seated on the top of the magnet member.

Preferably, the coil part has a coil shaft with its upper part connected to the mirror holder, inserted into the magnet part, and a coil wound for a predetermined number of times on the coil shaft.

More preferably, the coil shaft is shorter than the yoke in length, and has smaller exterior dimension than the interior dimension of the magnet member to be disposed in the center of the magnet part.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded perspective view illustrating a tilting assembly according to the present invention;

FIG. 2 is an overall perspective view illustrating a tilting actuator according to the present invention;

FIG. 3 is a bottom perspective view illustrating a tilting actuator with a partially sectioned stationary member according to the present invention;

FIG. 4 is a top perspective view illustrating a tilting actuator with a partially sectioned stationary member according to the present invention;

FIG. 5 is a plan view illustrating the stationary member adopted by tilting actuator according to the present invention;

FIG. 6 illustrates a mirror holder adopted by the tilting actuator according to the present invention, in which: (a) is a plan view, (b) is a front view, and (c) is a side view;

FIG. 7 is a perspective view illustrating a holder pillar adopted by the tilting actuator according to the present invention;

FIG. 8 is a perspective view illustrating a plate spring adopted by the tilting actuator according to the present invention;

FIG. 9 illustrates a magnet part adopted by the tilting actuator according to the present invention: (a) is a perspective view of a yoke, (b) is a perspective view of a magnet member, and (c) is a perspective view of an upper yoke;

FIG. 10 is a perspective view of a coil part adopted by the tilting actuator according to the present invention;

FIG. 11 is an outline view illustrating the images tilted by the tilting actuator to be formed on the screen; and

FIG. 12 is a block diagram illustrating a large-sized display device adopting the Digital Micro mirror Device (DMD).

### DETAILED DESCRIPTION OF THE PREFERRED EMBODIMENT

The following description will present a tilting member and a tilting actuator having the same with reference to the accompanying drawings.

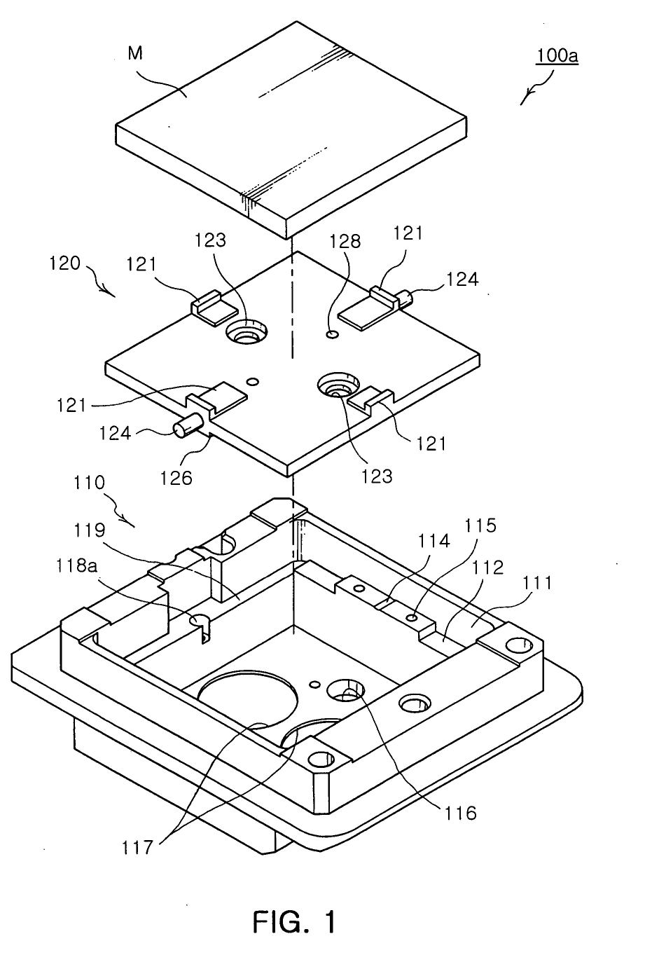

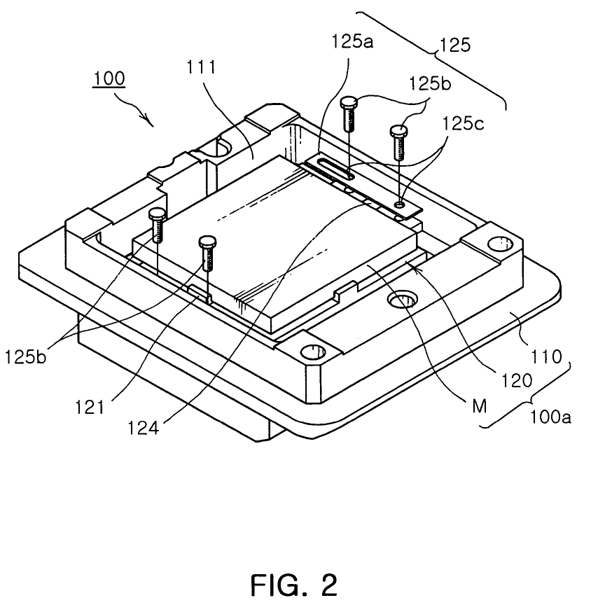

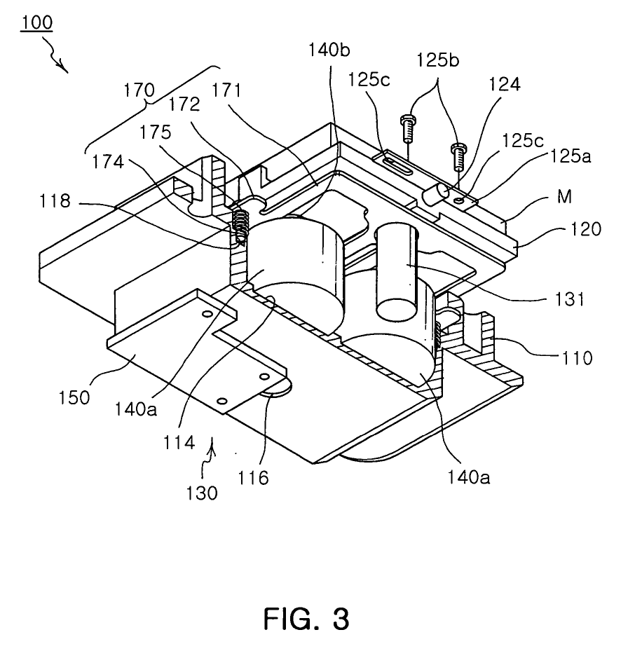

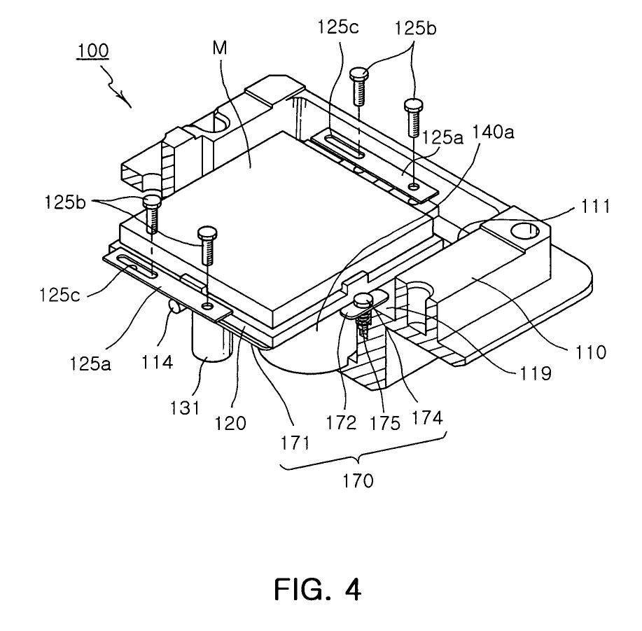

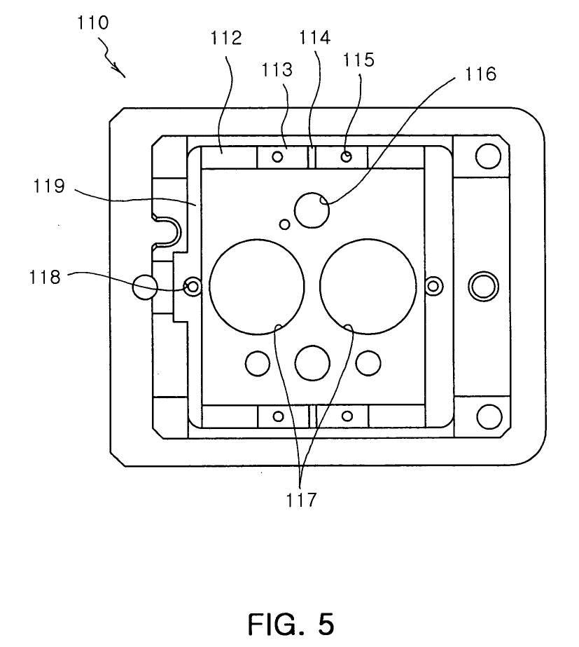

FIG. 1 is an exploded perspective view illustrating a tilting assembly according to the present invention; FIG. 2 is an overall perspective view illustrating a tilting actuator according to the present invention; FIG. 3 is a bottom perspective view illustrating a tilting actuator with a partially sectioned stationary member according to the present invention; and FIG. 4 is a top perspective view illustrating a tilting actuator with a partially sectioned stationary member according to the present invention.

The tilting actuator 100 according to the present invention is disposed in the light path between the DMD 50 and the projecting lens 60, repetitively tilting the mirror M, and thus the images formed on the screen S are repetitively superimposed on one another, inducing an optical illusion to enhance the visual resolution. The tilting actuator of the present invention includes a stationary member 110, a mirror holder 120, a holder pillar 130, a drive unit 140, and a power supply 150.

The tilting assembly 100a with the mirror M mounted, as shown in FIG. 1, includes a stationary member 110 and a mirror holder 120. The stationary member 100 has an open top and forms a rectangular frame-shaped opening 111, and has a closed bottom to form an inner space.

In the inner sides of the stationary member 110, first inner steps 112 protrude facing each other to have a mirror holder 120 seated rotatably thereon. Further, on the top of the first inner steps 112 protrude shaft supporting parts 113 on which shaft grooves 114 are formed to have a shaft 124 of the mirror holder 120 seated thereon.

At this time, the shaft groove 114 may have but not limited to a semicircular section to be in surface contact with the shaft 124, and may also have a V-shaped section to be in line contact with the shaft 124 to minimize friction during tilting.

In addition, on the surface floor of the stationary member 110, a pair of pillar holes 116, through which the holder pillars 130 are inserted, are provided by perforation in a bilaterally symmetrical structure. Also a pair of seating grooves 117 on which magnet parts 140a of the drive unit 140 seated and fixed, are provided in a bilaterally symmetrical structure.

At this time, an imaginary line connecting the centers of the pair of pillar holes 116, and another imaginary line connecting the centers of the pair of seating grooves 1176 cross each other orthogonally.

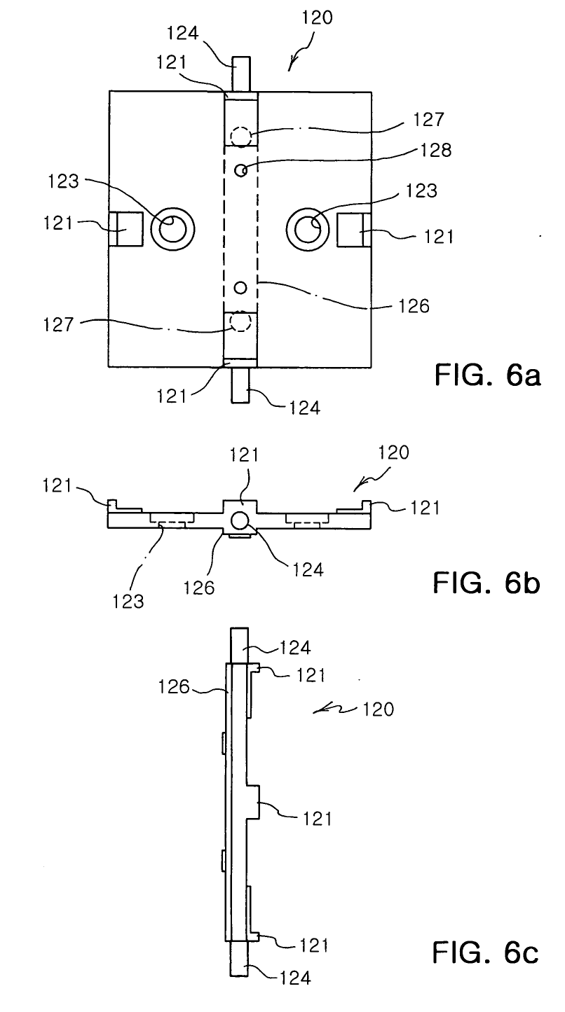

Moreover, the mirror holder 120 as shown in FIG. 1 and FIG. 6 (a), (b), and (c), including a rectangular plate member with a rectangular mirror M mounted on the top may be a molded member of metal or resin.

The mirror holder 120 has a plurality of mirror supporting parts 121 having an L-shaped section on the upper surface to prevent horizontal shift of the mirror M and to maintain the predetermined interval between the bottom of the mirror M and the upper surface of the mirror holder 121.

The plurality of mirror supporting parts 121 are disposed in a 90-degree interval about the center of the mirror holder 120.

Here, the mirror M mounted on the mirror supporting part 121 as shown may be fixed by, but not limited to, a bonding agent applied on the surface of the mirror supporting part 121.

In other words, the mirror M may be fixed between the mirror holder 120 and mirror cover (not shown) by assembling a rectangular frame-shaped mirror cover onto the upper part of the mirror holder 120.

In addition, on the left and right ends of the mirror holder 120 facing the shaft groove 114 of the stationary member 110a, a predetermined length of shaft 124 may be extended horizontally, or a predetermined depth of shaft hole 122 may be formed horizontally to insert and fix one end of the shaft 124 and to have the other end of the shaft 124 seated on the upper surface of the shaft groove 114.

At this time, on the upper part of the shaft 124 as shown in FIGS. 2 and 4, prevention means 125 for permitting the rotation while preventing the derailment of the shaft seated on the shaft groove 114 are provided.

The prevention means 125 include a fixing plate 125a disposed to be in surface contact with the shaft 124, and fastening means 125b inserted through a pair of through holes formed on the left and right sides of the fixing plates 125a to be bound to the fastening holes 115 formed in the left and right sides of the shaft groove 114.

Here, it is desirable that any one of the through holes 125c formed on the left and right sides of the fixing plate 125a is a slot which facilitates binding between the fastening means 125b and the fastening holes 115.

In addition, on the upper surface of the mirror holder 120, a coil shaft fixing hole 123 on which an upper part of the coil shaft for the coil part 140b is fixed, is provided by perforation in a bilaterally symmetrical structure about the tilting center line.

On the other hand, preferably, on the bottom of the mirror holder 120, a lower protrusion 126 protrudes vertically in parallel with the tilting center line through which the shaft 124 extends. Also, preferably, a contact groove 127 in contact with the upper part of the holder pillar 130 is provided on the lower protrusion 126. It is preferable that the inner side of the contact groove 127 is in point contact with the upper part of the holder pillar 130 so as to minimize the loss of electric power due to friction during the tilting of the mirror holder 120.

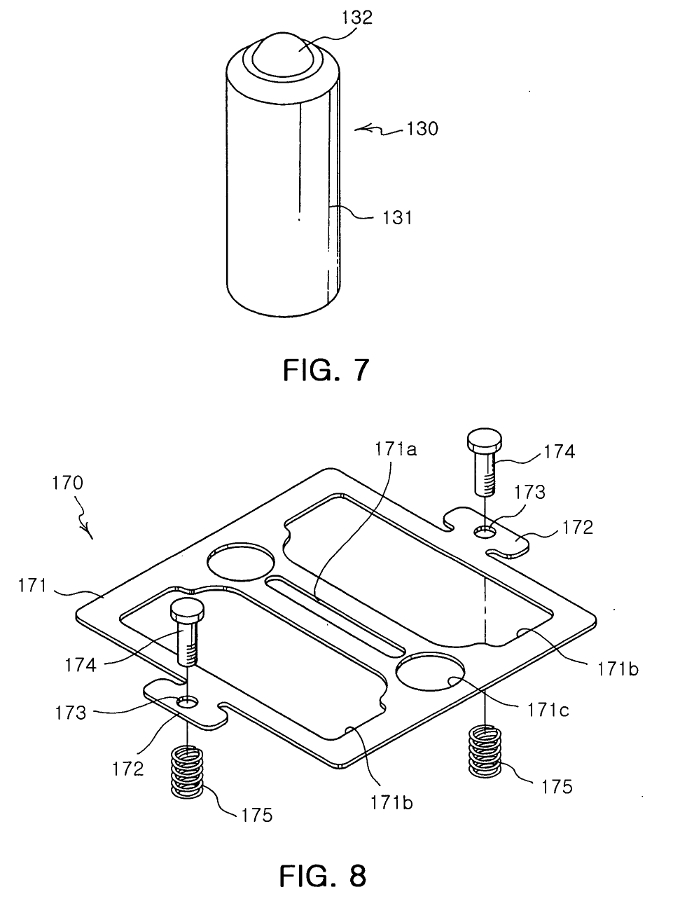

As shown in FIGS. 3, 4 and 7, a pair of holder pillars 130 are provided as supporting structures having the lower parts inserted into the pillar holes 116 formed by perforation and the upper parts in contact with the contact grooves 127 formed on the bottom of the lower protrusion 126 of the mirror holder 120.

Here, the holder pillars 130 include a cylindrical member 131 whose lower end is assembled into the stationary member 110, and a contact ball 132 disposed on the top of the cylindrical member 131 to resiliently contact the bottom of the mirror holder 120. Inside the cylindrical member 131, a spring member (not shown) is provided to resiliently support the contact ball upward.

In addition, in order to control the external force which is resiliently supporting the mirror holder 120, a male thread is formed in the outer surface of the lower end of the holder pillar 130 where as a female thread is formed on the pillar hole 116, so that the holder pillar 130 is screwed into the pillar hole 116 formed on the floor surface of the stationary member 110.

In the meantime, between the stationary member 110 and the mirror holder 120, as shown in FIGS. 2 to 4, a levelness-adjusting means 170 is provided to adjust the levelness of the mirror M to be congruent with the reference levelness of the upper surface of the stationary member 110.

The levelness-adjusting means 170, as shown in FIGS. 3, 4 and 8, have its center fixed on the bottom surface of the mirror holder 120 by a plurality of fastening means, and include a rectangular plate spring 171 having lateral protrusions 172 with the adjustment holes 173 formed by perforation on the left and right lateral sides of the plate spring 171.

Here, the plate spring is provided with a fixing hole 171a in a form of slot which is formed by perforation in length along the lower protrusion, in position corresponding to the plate spring hole 128 in the lower protrusion 126. The plate spring 171 is assembled onto the mirror holder 120 by inserting a plurality of fastening means into the plate spring fixing holes 128 of the mirror holder 120 through the above fixing hole 171a.

On the upper surface of the plate spring 171 where the fixing hole 171a is formed by perforation, a plurality of first and second openings 171b and 171c are formed in a predetermined dimension of circular shape, so that the magnet part 140a and the coil part 140b penetrate to be disposed therein without any obstruction. The shape and dimension of the first and second openings 171b and 171c may vary according to the shape of the section and the exterior dimension of the magnet part 140a and the coil part 140b.

In addition, on the top of the second inner steps 119 protruding to face each other in the inner sides of the stationary member 110, fastening holes 118 are formed corresponding vertically to the adjustment holes 173 of the lateral protrusions 172, and also, the adjusting members 174 with the lower ends bound to the fastening holes 118 are inserted through the adjustment holes 173.

At this time, the adjusting member 174 has a coil spring 175 resiliently supporting the lateral protrusion 172 of the plate spring 171 upward.

Moreover, the drive unit 140, as shown in FIGS. 2 and 3, includes the magnet part 140a generating a magnetic field, and the coil part 140b generating an electric field. The drive circuit 140 imparts repetitive and vertically reciprocated movement to the coil part 140b fixed on the mirror holder 120 via the reciprocated action of the magnetic field of the magnet part 140a and the electric field of the coil part 140b, thus repetitively tilting the mirror M of the mirror holder connected to the coil part 140b.

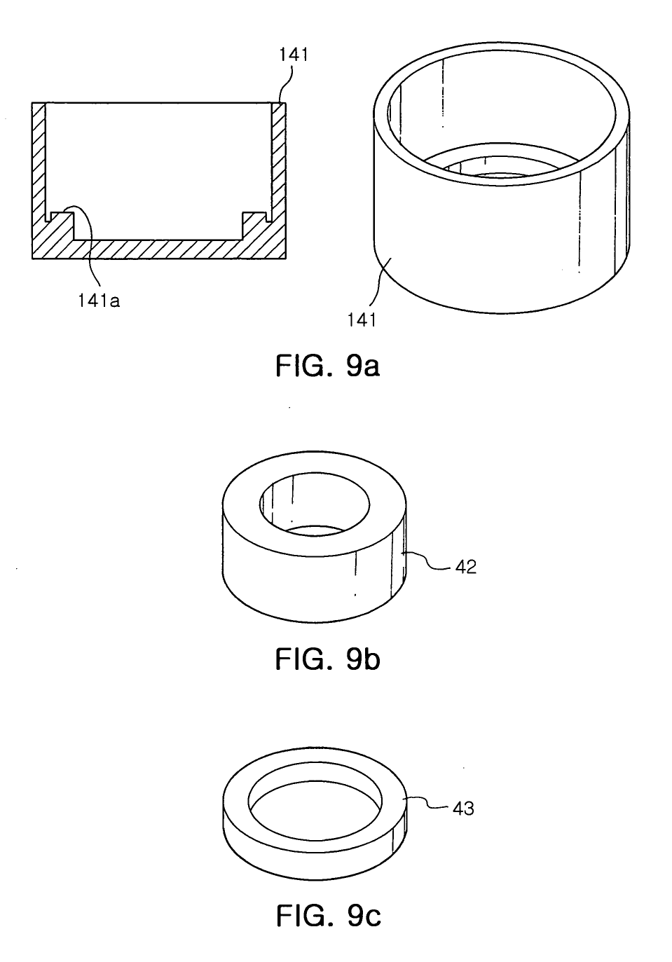

The pair of magnet parts 140a disposed in the lower part of the mirror holder 120 as shown in FIG. 9 (a), (b) and (c), includes a yoke 141 and a magnet 142. The yoke 141 is a cylindrical member having an open top and a closed bottom to have an inner space, fixed in its position by its lower end placed on the seating groove 117 formed on the floor surface of the stationary member 110. The magnet 142 is a donut-shaped magnet member disposed in the inner space of the yoke 141, generating a predetermined intensity of magnetic field.

Here, it is preferable that the magnet 142 is seated on the top of the inner step 141 protruding in an annular shape, in a predetermined height from the floor surface of the yoke 141, so that the magnetic flux flows easily toward the yoke 141.

In addition, it is preferable that the yoke 141 has an upper yoke 143 inserted through the upper part of the yoke 141 to be seated on the top of the magnet 142 to facilitate the flow of the magnet flux between the magnet 142 and the yoke 141.

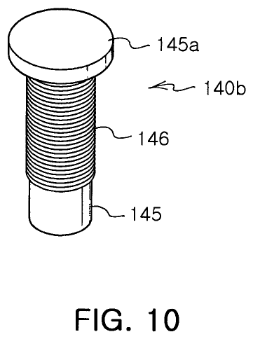

Moreover, the coil part 140b, inserted and piled up inside the magnet part 140a, as shown in FIG. 10, includes a coil shaft 145 and a coil 146. The coil shaft 145 is a predetermined length of shaft member which is fixed with its upper part assembled into the coil shaft fixing hole 123 perforated in the upper surface of the mirror holder 120. The coil 146 is wound on the coil shaft for a predetermined number of times and electrically connected to the power supply 150 to form a magnetic field on the coil shaft 145 when power is applied.

Here, it is preferable that the upper part of the coil shaft 145 has a head 145a having a larger exterior dimension than that of the body so that it is fixed by being stuck in the inner step formed inside the coil shaft fixing hole 123.

Here, the coil shaft 145, disposed in the center of the magnet part 140a, is shorter than the yoke 141 in length and has smaller exterior dimension than the interior dimension of the magnet 142 so that the lower end of the coil shaft does not touch the floor surface of the yoke 141 and the exterior surface of the coil shaft does not touch the interior surface of the magnet 142 during tilting.

In the meantime, the power supply 150 may be provided as a board member attached to the lower part of the stationary member 110 to be electrically connected to the coil 146 wound on the coil shaft 145 of the coil part 140b to supply power.

The power supply 150 includes a controller (not shown) which has a pair of left and right coil parts 140b connected to the mirror holder 120 alternately perform vertical reciprocating movement. The controller also alternates the polarity of the current applied to the coil 146 periodically, at the same time.

Accordingly, as the anode current is applied to a coil part 140b disposed on the bottom surface of the mirror holder 120 to operate upward, the cathode current is applied to the other coil part to operate downward, so that the mirror M in the mirror holder 120 is tilted about the tilting center line of the shaft 124.

According to the operation to tilt the mirror M by the tilting actuator with the above described construction, opposite polarities of current is applied to the pair of coil parts 140b which is electrically connected to the power supply 150 and disposed in a left and right pair between the mirror holder 120 and the stationary member 110.

Therefore, as opposite polarities of current runs on the coil wound in one direction on the pair of coil shafts 145 whose upper part is fixed on the mirror holder 120, a predetermined intensity of magnetic field is generated around the coil shaft 145.

Furthermore, as the coil part 140b including the yoke 141 and the magnet 142 is disposed inside the pair of left and right magnet parts 140a on the surface floor of the stationary member 110 to generate a predetermined intensity of the magnetic field, upward external force is generated at the coil part 140b on one side whereas downward external force is generated at the coil part 140b on the other side, according to the Fleming's left-hand rule.

In this case, the mirror holder 120 becomes tilted clockwise in a predetermined degree with respect to an imaginary horizontal line, equivalent to upward movement of the coil shaft 145 on one side and downward movement of the coil shaft on the other side, with the shaft 124 supported rotatable by the stationary member 110 as the tilting axis.

At the same time, as the mirror M integrally provided on the mirror holder 120 is tilted clockwise, the light incident through the DMD 50 on the mirror M is reflected on the tilted reflective side to be altered in its light path, and then irradiated on the screen S.

As the regulator of the power supply 150 supplies current alternately to the pair of left and right coil parts 140b according to a predetermined interval, the coil shafts 145 alternately perform repetitive vertical reciprocated movement about the tilting center line. In turn, the mirror holder 120 as well as the mirror M are tilted at a high-speed and the light incident through the DMD on the mirror M can be repetitively moved up and down or left and right on the screen.

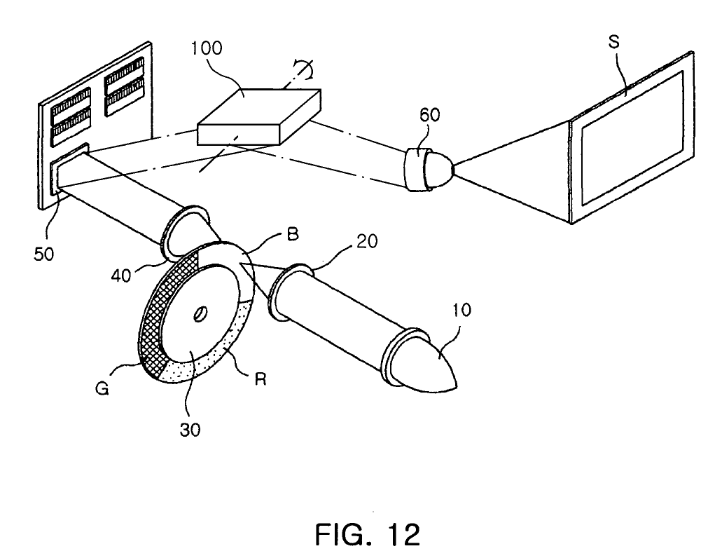

In other words, the white light generated at the light source 10, as shown in FIG. 12, comes to have the light of the color in the image formed in the DMD 50 as it passes through the color wheel 30. Thereafter, the image formed in the DMD 50 is reflected on the mirror M of the tilting actuator 100, and then enlarged by the projection lens 60 to be shown in a large-sized image.

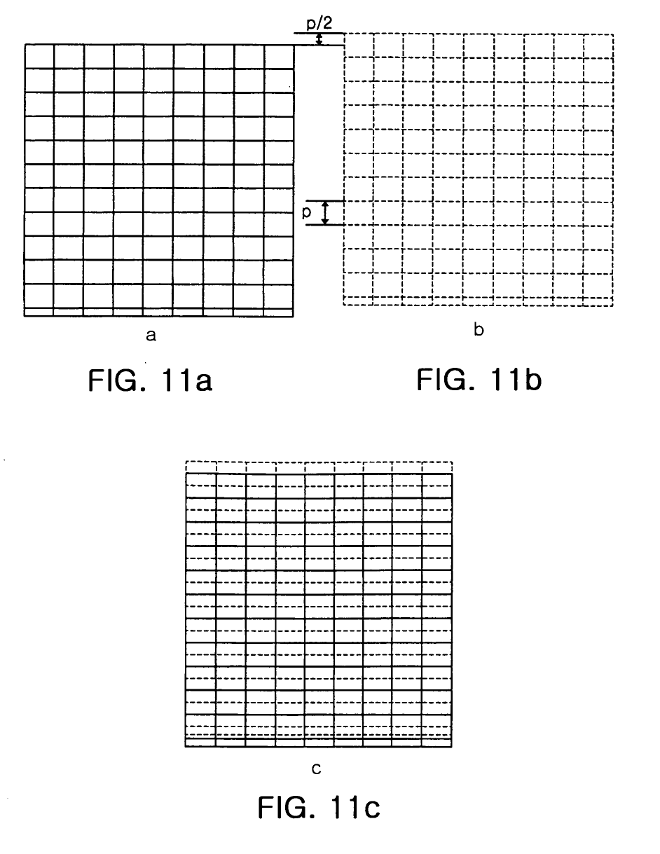

The image projected on the screen S corresponding to the initial position of the tilting actuator 100 may be illustrated as the image a in solid lines in FIG. 11 (a).

As the magnet part 140a of the drive unit 140 is driven by the external power source supplied to the tilting actuator 100 to impart vertical reciprocated movement to the coil axes 145 with its upper part connected to the mirror holder 120, the mirror holder 120 becomes tilted in a predetermined angle along with the mirror M thereon tilted in a fine angle as well. Thus, the image formed on the screen S is finely shifted on the screen S as shown in FIG. 11 to be shown as the image b in dotted lines.

As the image a and the image b are shown repetitively and periodically in a continuous manner on the screen S in a short interval of 0.002 seconds or less by the periodically repetitive movement of the drive unit 140, human eyes come to perceive this as a composite image c in FIG. 11 (c) with the images a and b superimposed on one another.

Supposing that the shift amount of the image by the tilting actuator 100 is p/2 which is the half the vertical height p of the original pixel size, the image a is superimposed on the image b for a half pixel. Accordingly, human eyes adapt to perceive the composite image c with the pixels half the original size as shown in FIG. 11 (c) owing to an optical illusion, resulting in substantially enhanced resolution.

In the meantime, if the levelness of the mirror M provided on the mirror holder 120 does not conform with the reference levelness of the upper surface of the stationary member 110, the pair of left and right levelness-adjusting means 170 provided between the stationary member 110 and the mirror holder 120 may be used to adjust the levelness of the mirror M.

In other words, as the adjustment members 174 bound to the fastening holes 118 of the stationary member 110 are tightened through the adjustment holes 173 of the either one of the lateral protrusions 171 protruding on the left and right sides of the plate spring 171 provided on the bottom surface of the mirror holder 120, the vertical interval between the lateral protrusion 171 and the stationary member 110 becomes narrow, tilting the mirror holder 120 as well as the plate spring to one side in the degree equivalent to the tightening amount of the adjustment members 174. Accordingly, the flatness of the mirror M mounted on the mirror holder 120 is accurately regulated within the reference value of 1.2 μm.

In addition, as the adjustment member 174 is tightened, the coil spring 175 provided thereof is compressed to generate external force that pushes the corresponding lateral protrusion 171 upward when the adjustment member 174 is loosened.

In the meantime, the degree of the upward displacement of the coil shaft 145 on one side as well as the downward displacement on the other side should always be maintained the same in order for the mirror to tilt in a uniform manner. In case of adjusting the upward and downward displacement amount of the coil axes 145 to change the tilting angle, the intensity of the current applied to the coil 146 wound on the coil shaft 145 can be adjusted to change the upward and downward displacement amount of the coil shaft 145, thus adjusting the tilting angle of the mirror M.

In addition, the coil part 140b disposed inside the magnet part 140a tends to tilt to one side during tilting driving due to the tilting structure of the mirror holder 120. However, the interior dimension of the magnet 142 is provided sufficiently larger than the maximum exterior dimension of the coil part 140b, taking account of the tilting angle of the mirror holder 120, to prevent the contact between the magnet part 140a fixed on the stationary member 110 and the coil part 140b fixed on the mirror holder 120.

According to the present invention with the above described construction, the magnet part and the coil part are provided between the mirror holder and the stationary member to tilt the mirror mounted on the mirror holder via the reciprocated action of the magnetic field of the magnet part and the electric field of the coil part. Therefore, the mirror according to the present invention is tilted more easily without noise or vibration compared with the conventional piezoelectric element, and the manufacturing costs are reduced.

In addition, the intensity of the current applied to the coil part may be adjusted to easily regulate the degree of tilting of the mirror, which results in facilitated process for improving the capacity of the actuator, allowing uniform tilting quality and capacity across the mass-produced actuators.

Moreover, the mirror which is tilted to alter the light path to be formed on the screen may be adjusted accurately and easily in the levelness, allowing obtainment of excellent picture quality.

While the present invention has been shown and described in connection with the preferred embodiments, it will be apparent to those skilled in the art that modifications and variations can be made without departing from the spirit and scope of the invention as defined by the appended claims.

What is claimed is:

1. A tilting assembly comprising:
a mirror reflecting a light;
a stationary member having an inner space;
a mirror holder supporting the mirror on its upper surface, and having a shaft supported rotatably by the stationary member to tilt about the shaft.

2. The tilting assembly according to claim 1, wherein the mirror is a plate member with reflective material applied on at least one of opposed sides thereof.

3. The tilting assembly according to claim 1, wherein the stationary member has a shaft supporting part with a shaft groove formed by depression of the surface to place the shaft thereon.

4. The tilting assembly according to claim 3, wherein the shaft groove has a semicircular section to be in surface contact with the shaft.

5. The tilting assembly according to claim 3, wherein the shaft groove has a V-shaped section to be in line contact with the shaft.

6. The tilting assembly according to claim 1, wherein the shaft is integrally formed in the left and right sides of the mirror holder which faces the shaft supporting part.

7. The tilting assembly according to claim 1, wherein the shaft is assembled into pillar holes formed in the left and right sides of the mirror holder which faces the shaft supporting part.

8. A tilting actuator comprising:
a stationary member having an inner space;
a mirror holder having a shaft supported rotatably by the stationary member, with a mirror on the top thereof, to tilt about the shaft; and
a drive unit connected to the mirror holder to apply vertical external force to the mirror holder via the reciprocal action of a magnetic field and an electric field.

9. The tilting actuator according to claim 8, wherein the mirror is a plate member with reflective material applied on at least one of opposed sides thereof.

10. The tilting actuator according to claim 8, wherein the stationary member comprises shaft supporting means including a pair of first inner steps protruding from the inner sides facing each other and shaft grooves formed on the first inner steps, respectively, to have the shaft seated rotatably thereon.

11. The tilting actuator according to claim 10, wherein the shaft groove has a semicircular section to be in surface contact with the shaft.

12. The tilting actuator according to claim 10, wherein the shaft groove has a V-shaped section to be in line contact with the shaft.

13. The tilting actuator according to claim 8, wherein the shaft is integrally formed in the left and right sides of the mirror holder which faces the shaft supporting part.

14. The tilting actuator according to claim 8, wherein the shaft is assembled into the pillar holes formed in the left and right sides of the mirror holder which faces the shaft supporting part.

15. The tilting actuator according to claim 8, wherein the mirror holder is a molded member of metal.

16. The tilting actuator according to claim 8, wherein the mirror holder is a molded member of resin.

17. The tilting actuator according to claim 8, wherein the mirror holder has a plurality of mirror supporting parts on the upper surface to prevent the horizontal shift of the mirror and to maintain a predetermined interval with the mirror.

18. The tilting actuator according to claim 8, further comprising means for permitting the rotation of the shaft while preventing the derailment of the shaft.

19. The tilting actuator according to claim 18, the prevention means comprise a fixing plate disposed to be in surface contact with the shaft, and fastening means inserted into the fastening holes of the stationary member through a pair of through holes formed on the left and right sides of the fixing plate.

20. The tilting actuator according to claim 18, wherein any one of the pair of through holes is a slot.

21. The tilting actuator according to claim 8, further comprising at least one holder pillar disposed between the mirror holder, and the holder pillar having an upper part touching the bottom of the mirror holder facing the center line of the shaft to support the mirror holder and a lower part fixed on the floor of the stationary member.

22. The tilting actuator according to claim 21, wherein the holder pillar comprises a cylindrical member with its lower part assembled into a pillar hole of the stationary member, and a contact ball disposed on the top of the cylindrical member to allow resilient contact with the mirror holder.

23. The tilting actuator according to claim 22, wherein the cylindrical member is screwed into the pillar hole.

24. The tilting actuator according to claim 22, wherein the mirror holder further comprises a lower protrusion, formed on the bottom of the mirror holder which is in contact with the upper part of the holder pillar, protruding along the center line of the shaft.

25. The tilting actuator according to claim 24, wherein the lower protrusion comprises a contact groove in point contact with the upper part of the holder pillar.

26. The tilting actuator according to claim 8, further comprising means for adjusting the levelness of the mirror disposed between the mirror holder and the stationary member.

27. The tilting actuator according to claim 26, wherein the levelness-adjusting means comprise: a plate spring whose center is fixed to the bottom of the mirror holder, having lateral protrusions on both sides facing the fastening holes formed on the second inner steps of the stationary member; and adjustment members bound to the fastening holes through adjustment holes formed on the lateral protrusions.

28. The tilting actuator according to claim 27, wherein the adjustment members comprise a coil spring resiliently supporting the lateral protrusions upward.

29. The tilting actuator according to claim 8, wherein the drive unit comprises at least one magnet part installed on the floor of the stationary member, and at least one coil part connected to the mirror holder.

30. The tilting actuator according to claim 29, wherein the magnet part comprises an yoke having an open top and a closed bottom, with the bottom fixed on the seating groove formed on the floor of the stationary member, and a magnet member disposed in the inner space of the yoke to generate magnetic field.

31. The tilting actuator according to claim 30, wherein the magnet member is seated on an annular protrusion protruding from the floor of the yoke in a predetermined height.

32. The tilting actuator according to claim 30, wherein the yoke comprises an upper yoke seated on the top of the magnet member.

33. The tilting actuator according to claim 29, wherein the coil part comprises: a predetermined length of a coil shaft with its upper part connected to the mirror holder, inserted inside the magnet part; and a coil wound for a predetermined number of times on the coil shaft.

34. The tilting actuator according to claim 33, wherein the coil shaft disposed in the center of the magnet part, is shorter than the yoke in length and has a smaller exterior dimension than the inner dimension of the magnet member.
